(19) United States
(12) Patent Application Publication
(10) Pub. No.: US 2003/0178611 A1
(43) Pub. Date: Sep. 25, 2003

(54) Turn buckle

(75) Inventor: Malcolm John Anderson, Hunters Hill (AU)

Correspondence Address: LADAS & PARRY, 26 WEST 61ST STREET, NEW YORK, NY, 10023, US

(73) Assignee: BROLGA 98 PTY LTD

(21) Appl. No.: 10/377,278

(22) Filed: Feb. 28, 2003

(30) Foreign Application Priority Data
Mar. 14, 2002 (AU) PS 1141

(51) Int. Cl. B66F 3/00

(52) U.S. Cl. 254/231; 403/43

(57) ABSTRACT

A turn buckle 10 that forms part of a stay of the mast of a sailing craft. The turn buckle 10 includes a cable attachment 12 that is fixed to a stay cable, and a threaded rod 14 to be attached to the boat hull. A turn member 16 is threadably attached to the rod and has fixed to it a bearing cap 18. The bearing cap 18 faces a bearing block 20 fixed to the cable attachment 12, while rotatable bearing elements 21 are located between the cap 18 and bearing block 20 to provide for relative rotation between the turn member 16 and attachment 12 to enable tensioning of the cable.

### TECHNICAL FIELD

The present invention relates to turn buckles and more particularly but not exclusively to turn buckles employed in boats, to tension cables securing a mast.

### BACKGROUND OF THE INVENTION

In sailing craft, a number of cables are used to secure the mast in a fixed orientation relative to the boat hull. In some craft, it is desirable to alter the tension in at least two of these cables, such as the main and lower “stays”. Traditionally, this tensioning of the cable or cables is by way of a turn buckle. The turn buckle includes a turn member that is rotated by a crew member to alter the tension in the cable. More particularly, the turn member is rotatably attached to the hull and is threadably engaged with a rod attached to the cable.

The above arrangement has a number of disadvantages including the excessive torque required to overcome friction between turn member and rod, and twisting of the cable.

### OBJECT OF THE INVENTION

It is the object of the present invention to overcome or substantially ameliorate at least one of the above disadvantages.

### SUMMARY OF THE INVENTION

There is disclosed herein a turn buckle to tension a cable securing a mast, said turn buckle includes:

a threaded rod to be attached to the hull;

a turn member with a threaded passage within which the rod is threadably engaged so that the rod at least partly extends into the passage;

a cable attachment to be fixed to the cable;

a bearing block attached to the cable attachment;

a bearing cap attached to the turn member having a bearing race facing the bearing block;

a plurality of rotatable bearing members located between the bearing block and raced; and wherein

said bearing elements are under compression when said rod and cable attachment are tensioned, with the tension being adjustable by movement of said turn member along said rod, with said bearing elements providing for relative rotation between the bearing cap and bearing block.

Preferably, said turn member is provided with a scale to enable an operator to gain some indication of the tension in the cable by visually observing an end of said rod with respect to said scale through an aperture in the turn member.

### BRIEF DESCRIPTION OF THE DRAWINGS

A preferred form of the present invention will now be described by way of example with reference to the accompanying drawings wherein:

FIG. 1 is a schematic part sectioned side elevation of a turn buckle; and

FIG. 2 is a schematic front elevation of the turn buckle of FIG. 1.

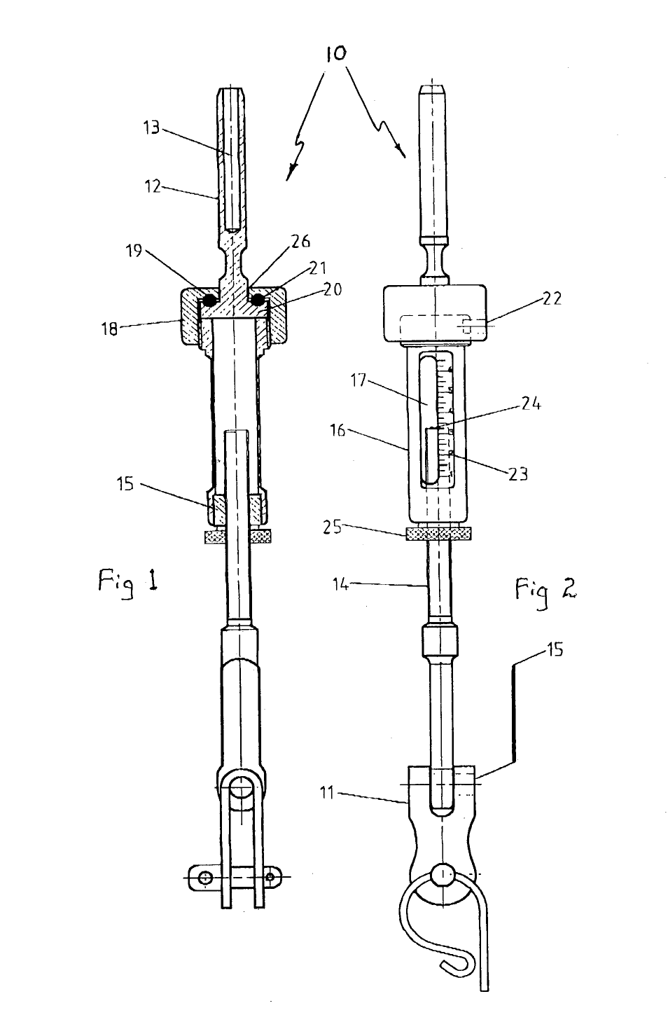

### DETAILED DESCRIPTION OF THE PREFERRED EMBODIMENTS

In the accompanying drawing, there is schematically depicted a turn buckle 10 forming part of a stay. The turn buckle 10 has a pivot member 11 attaching the turn buckle 10 to the hull. The other end of the turn buckle 10 has a cable attachment 12 having a longitudinal passage 13 within which a stay cable is fixed. The cable would extend to an upper portion of the mast and is tensioned to secure the mast in position and if so required has its tension adjusted to change the configuration of the mast. That is, by altering the cable tension the mast is resiliently deformed.

The turn buckle 10 includes a threaded rod 14 pivotably attached to the member 11 by means of a pin 15. The rod 14 is threadably engaged in a passage 15 of a turn member 16. The turn member 16 has a longitudinally extending central aperture 17 into which the rod 14 projects.

The upper end of the turn member 16 has attached to it a bearing cap 18 providing an upper bearing race 19 through which the attachment 12 passes via passage 26.

Attached to the lower end of the attachment 12 is a bearing block 20 that faces the race 19.

Located between the race 19 and bearing block 20 are spherical bearing element 21.

The bearing cap 18 is threadably secured to the turn member 16 and is maintained in position by one or more threaded fasteners 22.

Because the bearing elements 21 are placed under compression and are essentially interposed between the turn member 16 and attachment 12, the torque applied to the attachment 12 and therefore the cable secured thereto is minimised. Accordingly, problems associated with twisting of the stay cable are also ameliorated.

The bearing elements 22 also greatly aids in reducing the amount of torque required to rotate the turn member 16.

The turn member 16 is provided with a scale 23 that is used by a crew member to gain some indication of the tension in the associated cable. More particularly, the upper end 24 of the rod 14 is viewed relative to the scale 20 to enable the crew member to judge the tension in the associated cable.

A lock nut 25 is located between the nut 25 and turn member 16.

The claims defining the invention are as follows:

1. A turn buckle to tension a cable securing a mast, said turn buckle includes:
a threaded rod to be attached to the hull;
a turn member with a threaded passage within which the rod is threadably engaged so that the rod at least partly extends into the passage;
a cable attachment to be fixed to the cable;
a bearing block attached to the cable attachment;
a bearing cap attached to the turn member having a bearing race facing the bearing block;
a plurality of rotatable bearing members located between the bearing block and raced; and wherein
said bearing elements are under compression when said rod and cable attachment are tensioned, with the tension being adjustable by movement of said turn member along said rod, with said bearing elements providing for relative rotation between the bearing cap and bearing block.

2. The turn buckle of claim 1 wherein said turn member is provided with a scale to enable an operator to gain some indication of the tension in the cable by visually observing an end of said rod with respect to said scale through an aperture in the turn member.

3. The turn buckle of claim 1 or 2 wherein the cable attachment extends through the bearing cap.

4. The turn buckle of claim 3 wherein the bearing cap includes a bearing race providing a passage through which the cable attachment extends.

5. The turn buckle of claim 4 wherein the bearing cap generally surrounds the bearing block.

6. A turn buckle, substantially as hereinbefore described with reference to the accompanying drawing.
